(19) United States
(12) Patent Application Publication
(10) Pub. No.: US 2025/0377142 A1
(43) Pub. Date: Dec. 11, 2025

(54) REFRIGERANT MANIFOLD

(71) Applicant: Hanon Systems, Daejeon (KR)

(72) Inventor: Se Woong LEE, Daejeon (KR)

(73) Assignee: Hanon Systems, Daejeon (KR)

(21) Appl. No.: 19/182,428

(22) Filed: Apr. 17, 2025

(30) Foreign Application Priority Data
Jun. 5, 2024 (KR) 10-2024-0073575

(51) Int. Cl. F25B 41/42

(52) U.S. Cl. CPC F25B 41/42; F25B 2500/221

(57) ABSTRACT

The present invention relates to a refrigerant manifold. An object of the present invention is to provide a refrigerant manifold having a structure capable of particularly and effectively preventing an intermediate plate from deviating from an exact position. More specifically, an object of the present invention is to provide a refrigerant manifold having a plurality of restraint portions provided on first and second housings, protruding toward an intermediate plate to restrict a rotation of the intermediate plate, and configured to guide and support an exact position of an edge of the intermediate plate.

### CROSS REFERENCE TO RELATED APPLICATION

The present application claims priority to Korean Patent Application No. 10-2024-0073575, filed on Jun. 5, 2024, the entire contents of which are incorporated herein for all purposes by this reference.

### BACKGROUND OF THE INVENTION

### Field of the Invention

The present invention relates to a refrigerant manifold, and more particularly, to a refrigerant manifold having a structure capable of being effectively prevented from deviating from an exact position during an assembling process.

### Description of the Related Art

In general, various air conditioning systems, cooling systems, and the like are installed in vehicles. The air conditioning system approximately includes cooling and heating modules for adjusting air a temperature, a humidity, and the like in an interior space in which a vehicle occupant is present. The cooling system includes modules for cooling an engine, a motor, and the like to prevent the engine, the motor, and the like from being overheated. These various modules are configured to implement heating, desired cooling, and refrigerating operations by transferring heat while circulating heat exchange media such as a refrigerant and a coolant.

In particular, there are many heat exchangers intended to perform a cooling or heating process by using the refrigerant, a circulation route for the refrigerant is significantly complicated. Specifically, in case that pipes for connecting one heat exchanger to another heat exchanger and connecting another heat exchanger to still another heat exchanger are provided separately, a space of an engine room in the vehicle may become narrower because of the pipes as well as accessories configured to dispose, fix, and support the pipes. In order to solve these problems, there has been developed and widely used a refrigerant manifold that refers to a component in which the arrangement of complicated routes, through which refrigerants pass, is optimized in advance, and the routes are integrated.

Flow paths are formed in the refrigerant manifold and serve as pipes. Introduction/discharge flow ports provided at ends of the flow paths are connected to several other external devices. In addition, valves are provided to appropriately change the routes of the flow paths. Various configurations of the refrigerant manifolds are disclosed in Korean Patent Laid-Open No. 2023-0136829 (“Refrigerant Manifold for Vehicle,” Sep. 27, 2023), Korean Patent No. 2542576 (“Method of Manufacturing Manifold Main Body for Vehicle Refrigerant and Manifold Main Body for Vehicle Refrigerant Manufactured by Same,” Jun. 7, 2023), and the like.

The configuration of the flow path of the refrigerant manifold may be associated directly with a configuration of an air conditioning system provided in the vehicle, and the flow path of the refrigerant manifold may be variously designed. Meanwhile, as can be seen from the patent documents, a device configuration of the refrigerant manifold is generally configured such that at least one housing having a flow path shape is coupled to a plate stacked on and coupled to the housing and configured to define the flow path space by blocking an opened portion of the flow path shape.

FIG. 1 is a view illustrating an embodiment of a refrigerant manifold in the related art. There are refrigerant manifolds with various structures. Currently, a structure of a refrigerant manifold 100′ illustrated in FIG. 1 has been widely used. More specifically, the refrigerant manifold 100′, which is widely used, has a structure in which an intermediate plate 130′ is interposed between first and second housings 110′ and 120′ having through-holes and flow paths formed in plate surfaces. The flow paths convex/concavely formed in the first and second housings 110′ and 120′ are closed by the intermediate plate 130′ to define flow path spaces in which a refrigerant may flow. The through-holes formed in the first and second housings 110′ and 120′ are connected to external devices and serve to receive the refrigerant or discharge and supply the refrigerant, and the through-hole formed in the intermediate plate 130′ serves to allow the flow paths in the first and second housings 110′ and 120′ communicate with each other when the flow paths in the first and second housings 110′ and 120′ are required to be connected. In order to define various routes of the flow paths, various valves capable of changing the flow paths are naturally provided in the refrigerant manifold 100′. Additionally, devices, such as sensors for measuring temperature, pressure, and the like of the refrigerant may be further provided.

As illustrated in FIG. 1, the structure of the refrigerant manifold, which is currently widely used, is a structure in which three plate-shaped components are basically stacked. The plate-shaped component is made by hot forging or pressing. In a state in which the plate-shaped components are separately produced and stacked, the plate-shaped components are coupled by vacuum brazing, such that the refrigerant manifold is completely manufactured.

Various problems occur in case that the vacuum brazing cannot be performed in a state in which the three plate-shaped components are accurately disposed at exact positions. As described above, the intermediate plate has through-holes that allow the flow paths in the first or second housing to communicate with one another at particular positions. However, in case that the positions of the through-holes cannot be accurately aligned with the flow paths that need to communicate with one another, cross-sectional areas of the through-holes, through which the refrigerant passes, are decreased. For this reason, a flow rate, pressure, and the like of the refrigerant may be different from design values, and the refrigerant may leak through a gap between the misaligned portions. That is, the deviation from the exact position, particularly the deviation of the intermediate plate from the exact position, which occurs during the assembling process, is one of the problems that need to be necessarily prevented.

### DOCUMENTS OF RELATED ART

(Patent Document 1) Korean Patent Laid-Open No. 2023-0136829 (“Refrigerant Manifold for Vehicle,” Sep. 27, 2023)
(Patent Document 2) Korean Patent No. 2542576 (“Method of Manufacturing Manifold Main Body for Vehicle Refrigerant and Manifold Main Body for Vehicle Refrigerant Manufactured by Same,” Jun. 7, 2023)

### SUMMARY OF THE INVENTION

The present invention is proposed to solve these problems and aims to provide a refrigerant manifold having a structure capable of effectively and particularly preventing an intermediate plate from deviating from an exact position during an assembling process. More specifically, the present invention aims to provide a refrigerant manifold having a plurality of restraint portions provided on first and second housings, protruding toward an intermediate plate to restrict a rotation of the intermediate plate, and configured to guide and support an exact position of an edge of the intermediate plate.

In order to achieve the above-mentioned objects, the present invention provides a refrigerant manifold 100 including: a first housing 110 having a plurality of flow paths; a second housing 120 having a plurality 41 flow paths; an intermediate plate 130 interposed between the first and second housings 110 and 120 and configured to define a flow path space by blocking an opening portion of a flow path formed in the first or second housing 110 or 120; and a plurality of restraint portions formed between the intermediate plate 130 and the first or second housing 110 or 120 to restrict a deviation or rotation of the intermediate plate 130 from an exact position.

In this case, the restraint portion may protrude from the first or second housing 110 or 120 toward the intermediate plate 130, and an inner surface of the restraint portion may be formed to be tightly attached to an outer peripheral line of the intermediate plate 130 at the exact position to restrict a deviation or rotation of the intermediate plate 130 from the exact position.

In addition, the restraint portion may be formed on a straight portion on the first or second housing 110 or 120 or formed on a processing position guide jig on the first or second housing 110 or 120.

In addition, at least one restraint portion may be provided on the first housing 110, and at least one restraint portion may be provided on the second housing 120, such that the plurality of restraint portions are provided so that at least one pair of restraint portions are provided on the refrigerant manifold 100, and at least one pair of directions, among the directions restricted by the plurality of restraint portions, may be perpendicular to each other.

In the specific embodiment, the restraint portions may be formed as two restraint portions that are a first-first restraint portion 111 and a first-second restraint portion 112 respectively formed on two different straight portions on the first housing 110, and the directions restricted by the first-first restraint portion 111 and the first-second restraint portion 112 may be perpendicular to each other.

In addition, the restraint portions may be formed as two restraint portions that are a second-first restraint portion 121 and a second-second restraint portion 122 respectively formed on two different jigs on the second housing 120, at least one of the second-first restraint portion 121 and the second-second restraint portion 122 may restrict one or more directions, and at least one of the directions restricted by the second-first restraint portion 121 and at least one of the directions restricted by the second-second restraint portion 122 may be perpendicular to each other.

In addition, when a plane defined by the intermediate plate 130 is referred to as a reference plane, the restraint portions may be distributed and disposed upward, downward, leftward, and rightward so that the first-first restraint portion 111, the first-second restraint portion 112, the second-first restraint portion 121, and the second-second restraint portion 122 do not overlap one another on the reference plane.

In addition, the refrigerant manifold 100 may further include: at least one pair of penetration pins 140 provided at a position, at which the first housing 110, the second housing 120, and the intermediate plate 130 triply overlap, and configured to penetrate all the first housing 110, the second housing 120, and the intermediate plate 130, in which the penetration pins 140 enhance the restriction of the deviation or rotation of the intermediate plate 130 from the exact position.

In this case, in the refrigerant manifold 100, at least one restraint portion may be formed on a straight portion on the first or second housing 110 or 120, and the pair of penetration pins 140 may be disposed to be spaced apart from each other in a direction perpendicular to a direction restricted by at least one restraint portion formed on the straight portion on the first or second housing 110 or 120.

In addition, the refrigerant manifold 100 may include the plurality of restraint portions, and a larger number of restraint portions are distributed at a side opposite to a side at which the pair of penetration pins 140 are disposed.

In addition, an external heat exchanger may be connected to a portion of the refrigerant manifold 100 where the pair of penetration pins 140 are disposed, a pair of flow ports may be provided to receive an introduced refrigerant from the external heat exchanger or discharge and supply the refrigerant to the external heat exchanger, a direction in which the pair of flow ports are spaced apart from each other and a direction in which the pair of penetration pins 140 are spaced apart from each other may be perpendicular to each other, and an intersection point between a first connection line, which connects centers of the pair of flow ports, and a second connection line, which connects centers of the pair of penetration pins 140, may overlap center points of the first and second connection lines.

### BRIEF DESCRIPTION OF THE DRAWINGS

FIG. 1 is a view illustrating an embodiment of a refrigerant manifold in the related art.

FIG. 2 is an exploded view illustrating a refrigerant manifold of the present invention.

FIG. 3 is a view illustrating first and second housings of the refrigerant manifold of the present invention.

FIG. 4 is a top plan view illustrating an intermediate plate of the refrigerant manifold of the present invention.

FIG. 5 is a perspective view illustrating the intermediate plate of the refrigerant manifold of the present invention.

FIG. 6 is an assembled view illustrating the first housing and the intermediate plate of the refrigerant manifold of the present invention.

FIG. 7 is an assembled view illustrating the second housing and the intermediate plate of the refrigerant manifold of the present invention.

FIG. 8 is a view illustrating a triple-overlap structure of the refrigerant manifold of the present invention.

FIG. 9 is a view illustrating an assembling position and an assembling cross-section of a penetration pin of the refrigerant manifold of the present invention.

### DETAILED DESCRIPTION OF THE INVENTION

Hereinafter, a refrigerant manifold according to the present invention configured as described above will be described in detail with reference to the accompanying drawings.

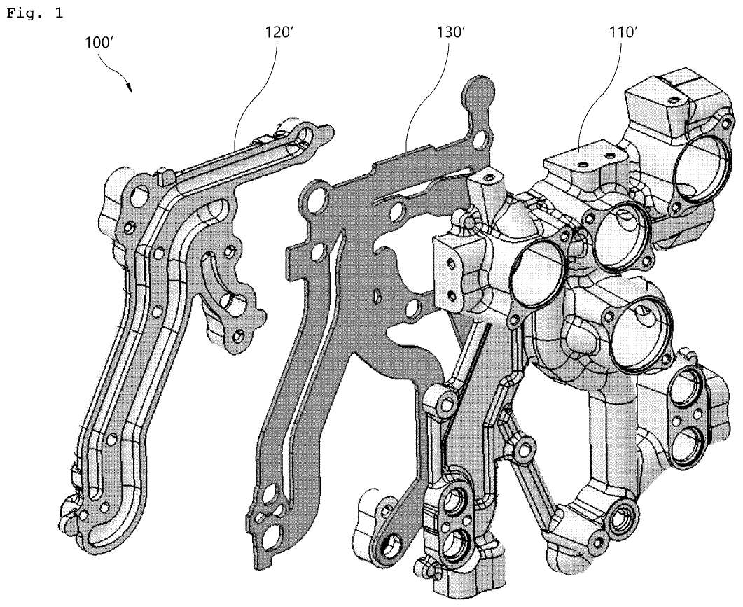

A refrigerant manifold 100 of the present invention basically has a structure in which a first housing 110, an intermediate plate 130, and a second housing 120 are sequentially and triply stacked. That is, the refrigerant manifold 100 has a basic structure of a refrigerant manifold illustrated in FIG. 1. The components will be briefly described. First, the first housing 110 has a plurality of flow paths, and the second housing 120 has a plurality of flow paths. The intermediate plate 130 is interposed between the first and second housings 110 and 120 and blocks opening portions of the flow paths formed in the first housing 110 or the second housing 120, thereby defining flow path spaces.

In this case, the refrigerant manifold 100 of the present invention includes structures capable of effectively and particularly preventing the intermediate plate from deviating from an exact position during an assembling process. Among the structure, the main structure is a plurality of restraint portions. That is, the restraint portions are formed between the intermediate plate 130 and the first housing 110 or the second housing 120 in order to restrict a deviation or rotation of the intermediate plate 130 from the exact position. More specifically, the restraint portion protrudes from the first housing 110 or the second housing 120 toward the intermediate plate 130, and an inner surface of the restraint portion is formed to be tightly attached to an outer peripheral line of the exact position of the intermediate plate 130. Therefore, the restraint portion may effectively restrict the rotation of the intermediate plate by guiding and supporting an exact position of an edge of the intermediate plate.

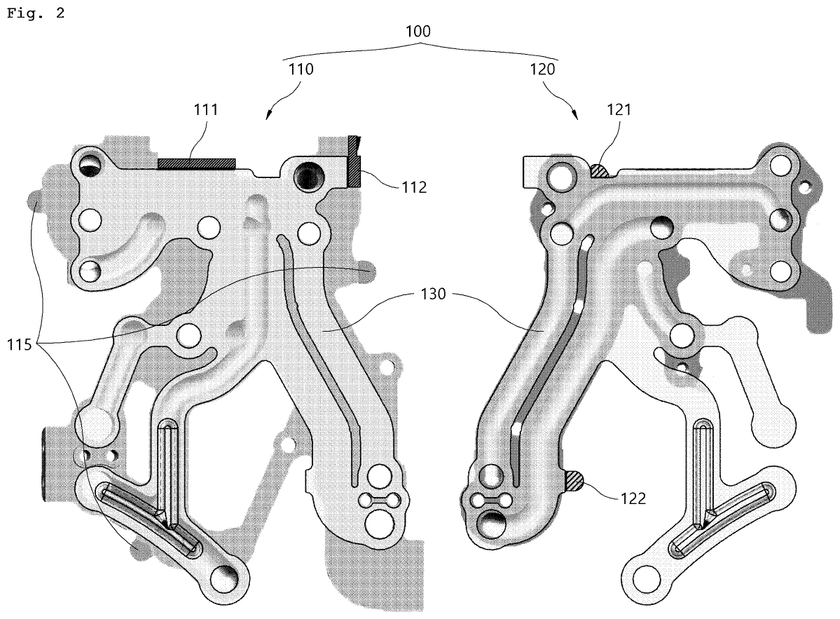

FIG. 2 is an exploded view of the refrigerant manifold of the present invention and illustrates the intermediate plate 130 is stacked on the housings in a state in which the first housing 110 and the second housing 120 are spread leftward and rightward. More specifically, first, the left view in FIG. 2 illustrates a lower surface of the intermediate plate 130 that is visible in a state in which an upper surface of the intermediate plate 130 is in surface contact with a lower surface of the first housing 110. In addition, the right view in FIG. 2 illustrates the upper surface of the intermediate plate 130 that is visible in a state in which the lower surface of the intermediate plate 130 is in surface contact with an upper surface of the second housing 120. That is, FIG. 2 illustrates the intermediate plate 130 twice. This is to clearly show a positional relationship between each of the first and second housings 110 and 120 and the intermediate plate 130. Actually, one first housing 110, one intermediate plate 130, and one second housing 120 are sequentially and triply stacked and define the refrigerant manifold 100.

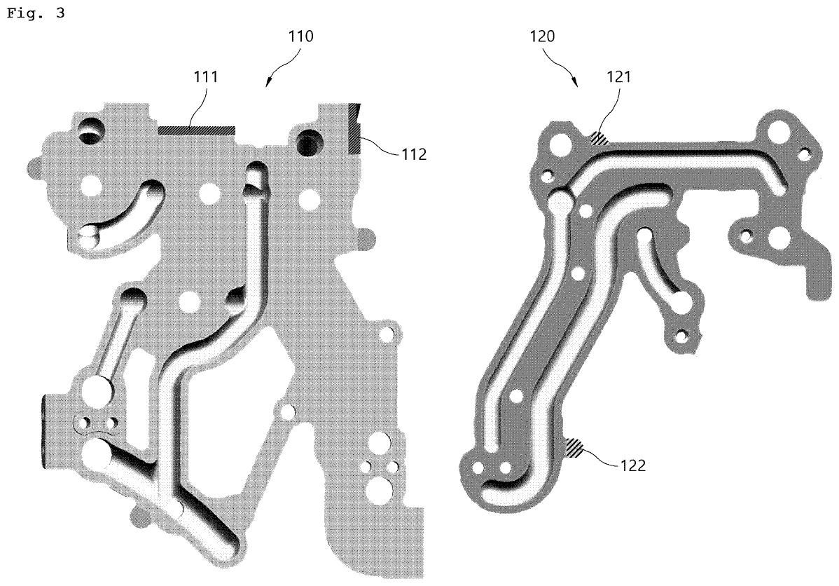

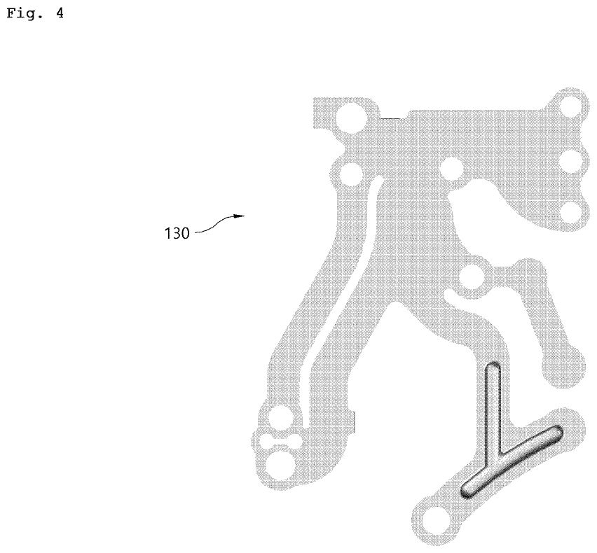

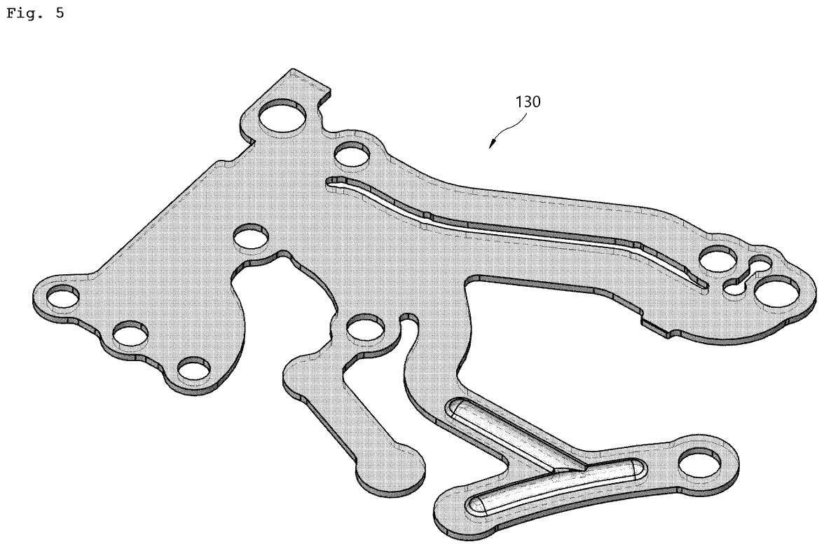

FIG. 3 is a view illustrating the first and second housings of the refrigerant manifold of the present invention, i.e., illustrates a state in which the intermediate plate 130 in FIG. 2 is separated. FIG. 4 is a top plan view of the intermediate plate of the refrigerant manifold of the present invention, i.e., a view at the same time point as the shape of the intermediate plate 130 in a state in which the intermediate plate 130 is stacked on the second housing 120 in FIG. 2, and the upper surface of the intermediate plate 130 is visible. FIG. 5 is a perspective view of the intermediate plate of the refrigerant manifold of the present invention and intuitively and clearly illustrates that the entire intermediate plate 130 defines a plane. In this case, hereinafter, the plane defined by the intermediate plate 130 is referred to as a “reference plane”.

As illustrated in FIG. 2, the plurality of restraint portions are provided and distributed on the first housing 110 and the second housing 120. More specifically, the restraint portions are formed on a straight portion of the first housing 110 or the second housing 120 or formed on a processing position guide jig on the first housing 110 or the second housing 120. More specifically, the “processing position guide jig” refers to a portion where a process facility holds the stacked assembly during a process of performing vacuum brazing in the state in which the first housing 110, the intermediate plate 130, and the second housing 120 are stacked and assembled. In FIG. 2, portions 115, which are formed in small, round cross-sectional shapes on an outer periphery of the first housing 110, correspond to the processing position guide jigs. Of course, the jig is also formed on the second housing 120. In the embodiment of the present invention, all the processing position guide jigs on the second housing 120 also serve as the restraint portions.

In this case, when all the restraint portions are formed in one direction even though many restraint portions are formed, it may be difficult to effectively prevent a rotation of the intermediate plate 130. Therefore, at least one restraint portion is provided on each of the first housing 110 and the second housing 120, such that the plurality of restraint portions are provided so that at least one pair of restraint portions are formed in the refrigerant manifold 100. Among the directions restricted by the plurality of restraint portions, at least one pair of directions may be perpendicular to each other.

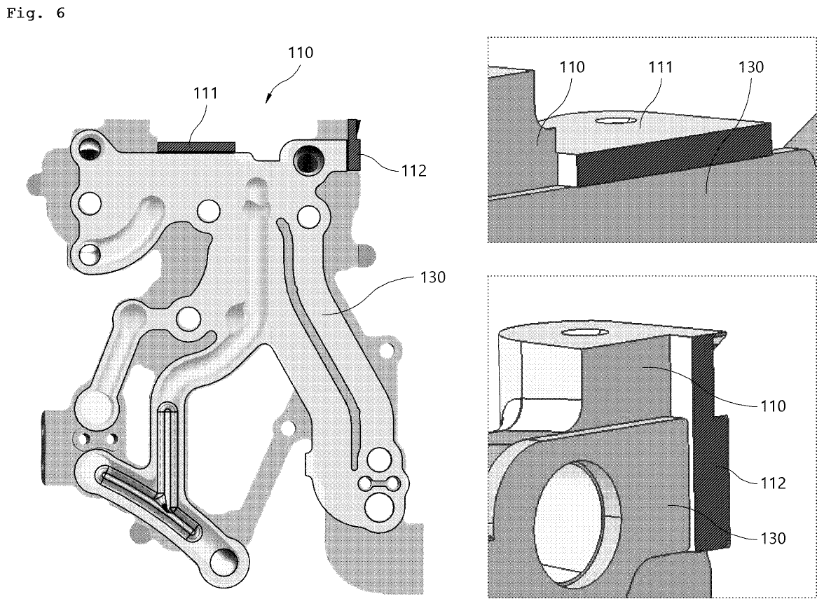

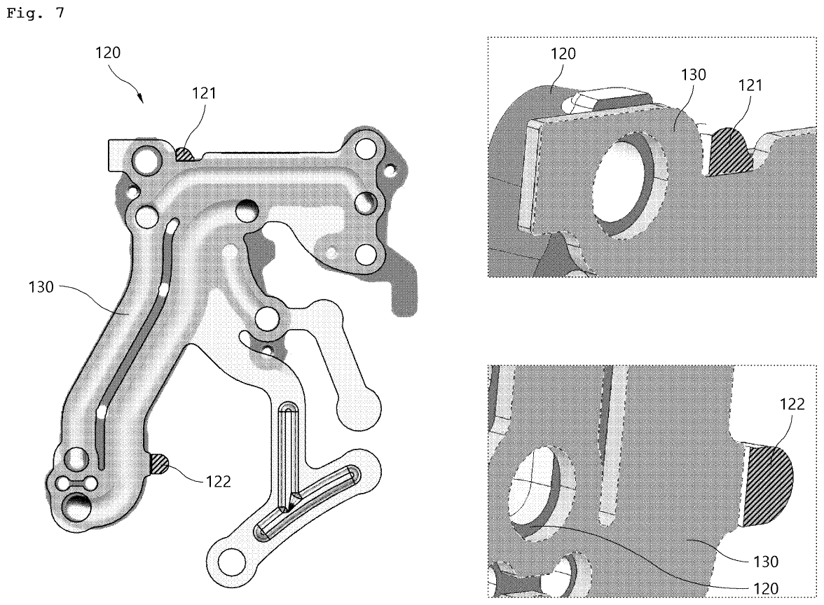

A specific embodiment of the restraint portion will be described in more detail with reference to FIGS. 6 and 7.

FIG. 6 is an assembled view illustrating the first housing and the intermediate plate of the refrigerant manifold of the present invention, and the left view in FIG. 6 is identical to the left view in FIG. 2. That is, the left view in FIG. 6 illustrates the lower surface of the intermediate plate 130 that is visible in the state in which the upper surface of the intermediate plate 130 is in surface contact with the lower surface of the first housing 110. In addition, the right view in FIG. 6 is an enlarged perspective view illustrating the embodiments of the restraint portions formed on the first housing 110. In the embodiment in FIG. 6, the two restraint portions are formed as a first-first restraint portion 111 and a first-second restraint portion 112 respectively formed on two different straight portions on the first housing 110. As can be seen from the enlarged perspective view, i.e., the right view in FIG. 6, the first-first restraint portion 111 and the first-second restraint portion 112 protrude, and a thickness-side surface of the intermediate plate 130 is supported on an inner surface of the first-first restraint portion 111 and an inner surface of the first-second restraint portion 112. In this case, as can be seen from the left view in FIG. 6, the directions restricted by the first-first restraint portion 111 and the first-second restraint portion 112 are perpendicular to each other. That is, in the embodiment in FIG. 6, the first-first restraint portion 111 extends in a leftward/rightward direction (based on the drawings) and restricts a motion in an upward/downward direction, and the first-second restraint portion 112 extends in the upward/downward direction (also based on the drawings) and restricts a motion in the leftward/rightward direction. With the above-mentioned configuration, the rotation of the intermediate plate 130 may be effectively restricted.

FIG. 7 is an assembled view illustrating the second housing and the intermediate plate of the refrigerant manifold of the present invention, and the left view in FIG. 7 is identical to the right view in FIG. 2. That is, the left view in FIG. 7 illustrates the upper surface of the intermediate plate 130 that is visible in the state in which the lower surface of the intermediate plate 130 is in surface contact with the upper surface of the second housing 120. In addition, the right view in FIG. 7 is an enlarged perspective view illustrating the embodiments of the restraint portions formed on the second housing 120. In the embodiment in FIG. 7, the two restraint portions are formed as a second-first restraint portion 121 and a second-second restraint portion 122 respectively formed on two different jigs on the second housing 120. As can be seen from the enlarged perspective view, i.e., the right view in FIG. 7, the second-first restraint portion 121 and the second-second restraint portion 122 protrude, and the thickness-side surface of the intermediate plate 130 is supported on an inner surface of the second-first restraint portion 121 and an inner surface of the second-second restraint portion 122. In this case, as can be seen from the left view in FIG. 7, at least one of the second-first restraint portion 121 and the second-second restraint portion 122 restricts one or more directions, and at least one of the directions restricted by the second-first restraint portion 121 and at least one of the directions restricted by the second-second restraint portion 122 are formed to perpendicular to each other. That is, in the embodiment in FIG. 7, the second-first restraint portion 121 restricts all the motions in the upward/downward direction and the leftward/rightward direction (based on the drawings), and the second-second restraint portion 122 restricts the motion in the leftward/rightward direction (also based on the drawings). With the above-mentioned configuration, the rotation of the intermediate plate 130 may be effectively restricted.

The restraint portions may be provided only on the first housing 110 or formed only on the second housing 120. However, the restraint portions may be formed on both the first housing 110 and the second housing 120, which may enhance the restriction of the rotation of the intermediate plate 130. Further, as illustrated in FIGS. 6 and 7, when the restraint portions are formed (when the plane defined by the intermediate plate 130 is referred to as the reference plane), the first-first restraint portion 111, the first-second restraint portion 112, the second-first restraint portion 121, and the second-second restraint portion 122 may be distributed upward, downward, leftward, and rightward so as not to overlap one another on the reference plane. That is, in case that the restraint portions are concentrated in any one region even though many restraint portions are formed, the restriction of the deviation or rotation from the exact position cannot be properly performed. Therefore, the plurality of restraint portions may be distributed as widely as possible.

Further, the refrigerant manifold 100 of the present invention may further include penetration pins 140 as well as the restraint portions, thereby enhancing the effect of preventing the intermediate plate 130 from deviating or rotating from the exact position.

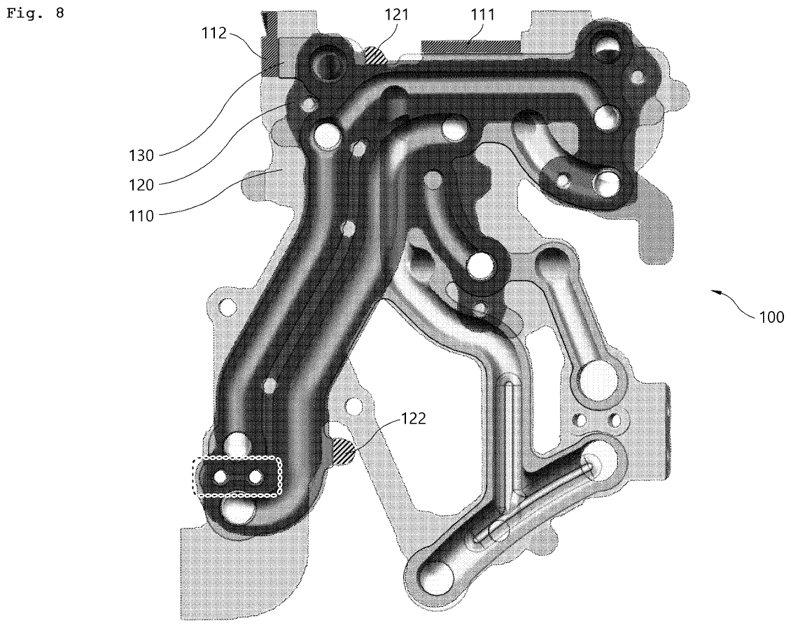

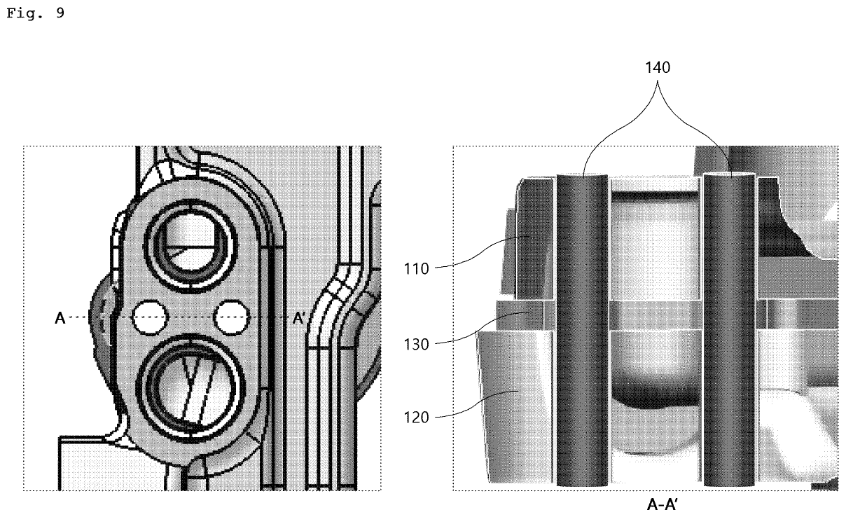

FIG. 8 illustrates a triple-overlap structure of the refrigerant manifold of the present invention. That is, FIG. 8 illustrates a shape made by folding the view in FIG. 2 in half. The portion indicated by the dotted quadrangle in FIG. 8 is a position at which the first housing 110, the second housing 120, and the intermediate plate 130 triply overlap. In this position, the penetration pin 140 penetrates all the first housing 110, the second housing 120, and the intermediate plate 130. FIG. 9 illustrates assembling positions and assembling cross-sections of the penetration pins of the refrigerant manifold of the present invention and appropriately illustrates a state in which the penetration pins 140 penetrate the three components.

Meanwhile, if one penetration pin 140 is provided, it is impossible to restrict a rotation of the intermediate plate 130 about a rotation axis, i.e., the penetration pin 140. That is, at least one pair of penetration pins 140 need to be provided. In addition, a direction in which the penetration pins 140 are disposed to be spaced apart from each other may be a direction in which the rotation restriction may be effectively performed. With reference to FIG. 2 or the like described above, the refrigerant manifold 100 of the present invention is formed such that at least one restraint portion is formed on the straight portion on the first housing 110 or the second housing 120. In this case, the pair of penetration pins 140 may be disposed to be spaced apart from each other in the direction perpendicular to the direction restricted by at least one restraint portion formed on the straight portion on the first housing 110 or the second housing 120. With the above-mentioned configuration, the restriction direction of the restraint portions formed on the straight portions and the restriction direction of the pair of penetration pins 140 are perpendicular to each other, which may further improve the effect of restricting the rotation of the intermediate plate 130.

Meanwhile, in case that the pair of penetration pins 140 are provided as described above, the rotation restricting effect of the corresponding part is significantly high. The rotation restricting effect may be naturally improved when the structures of the penetration pins are distributed and disposed at several positions. However, there are not many portions having all the triple-overlap structures, and there is a limitation in that a process of newly forming holes, a process of inserting and fixing the pins, and the like need to be added to substantially apply the structures of the penetration pins. This is why the present invention adopts the above-mentioned restraint portions. However, considering that the rotation restricting effect of the penetration pins 140 is significant, as described above, the restraint portions may be less formed at a side at which the pair of penetration pins 140 are formed. That is, the refrigerant manifold 100 may include the plurality of restraint portions, and a larger number of restraint portions are distributed at the side opposite to the side at which the pair of penetration pins 140 are disposed.

Further, an external heat exchanger is connected to a portion of the refrigerant manifold 100 where the pair of penetration pins 140 are disposed. More specifically, the dotted quadrangle in FIG. 8 indicates the portion to which the external heat exchanger is connected. The external heat exchanger of the refrigerant manifold in the embodiment illustrated in FIGS. 2 to 9 is a water-cooled condenser, but the present invention is, of course, not limited thereto. In this case, a pair of flow ports are provided in the portion to which the external heat exchanger is connected. The pair of flow ports naturally serve to receive the introduced refrigerant from the external heat exchanger or discharge and supply the refrigerant to the external heat exchanger. In this case, a direction in which the pair of flow ports are spaced apart from each other and a direction in which the pair of penetration pins 140 are spaced apart from each other may be perpendicular to each other. An intersection point between a first connection line, which connects centers of the pair of flow ports, and a second connection line, which connects centers of the pair of penetration pins 140, overlaps the center points of the first and second connection lines. With the above-mentioned configuration, it is possible to improve both the structural stability and the rotation restricting effect at the portion where the refrigerant manifold 100 is connected to the external heat exchanger.

According to the present invention, the refrigerant manifold having the structure in which the first housing, the intermediate plate, and the second housing are sequentially and triply stacked may particularly and effectively prevent the intermediate plate from deviating from the exact position during the assembling process. Specifically, in the present invention, the plurality of restraint portions protruding toward the intermediate plate are formed on the first and second housings and guide and support the exact position of the edge of the intermediate plate, which may effectively restrict the rotation of the intermediate plate.

Because the intermediate plate is prevented from deviating from the exact position during the assembling process, it is possible to basically prevent problems caused by the deviation of the intermediate plate from the exact position, i.e., a problem in which efficiency deteriorates because a flow rate, pressure, and the like of the refrigerant do not reach design values because of a change in cross-sectional area of the communication hole, and a problem in which the refrigerant leaks because the assembling process is performed at an incorrect position.

The present invention is not limited to the above embodiments, and the scope of application is diverse. Of course, various modifications and implementations made by any person skilled in the art to which the present invention pertains without departing from the subject matter of the present invention claimed in the claims.

### DESCRIPTION OF REFERENCE NUMERALS

100: Refrigerant manifold
110: First housing
111: First-first restraint portion
112: First-second restraint portion
120: Second housing
121: Second-first restraint portion
122: Second-second restraint portion
130: Intermediate plate
140: Penetration pin

What is claimed is:

1. A refrigerant manifold comprising:
a first housing having a plurality of flow paths;
a second housing having a plurality of flow paths;
an intermediate plate interposed between the first and second housings and configured to define a flow path space by blocking an opening portion of a flow path formed in the first or second housing; and
a plurality of restraint portions formed between the intermediate plate and the first or second housing to restrict a deviation or rotation of the intermediate plate from an exact position.

2. The refrigerant manifold of claim 1, wherein the restraint portion protrudes from the first or second housing toward the intermediate plate, and an inner surface of the restraint portion is formed to be tightly attached to an outer peripheral line of the intermediate plate at the exact position to restrict a deviation or rotation of the intermediate plate from the exact position.

3. The refrigerant manifold of claim 2, wherein the restraint portion is formed on a straight portion on the first or second housing or formed on a processing position guide jig on the first or second housing.

4. The refrigerant manifold of claim 3, wherein at least one restraint portion is provided on the first housing, and at least one restraint portion is provided on the second housing, such that the plurality of restraint portions are provided so that at least one pair of restraint portions are provided on the refrigerant manifold, and
wherein at least one pair of directions, among the directions restricted by the plurality of restraint portions, are perpendicular to each other.

5. The refrigerant manifold of claim 3, wherein the restraint portions are formed as two restraint portions that are a first-first restraint portion and a first-second restraint portion respectively formed on two different straight portions on the first housing, and
wherein the directions restricted by the first-first restraint portion and the first-second restraint portion are perpendicular to each other.

6. The refrigerant manifold of claim 5, wherein the restraint portions are formed as two restraint portions that are a second-first restraint portion and a second-second restraint portion respectively formed on two different jigs on the second housing,
wherein at least one of the second-first restraint portion and the second-second restraint portion restricts one or more directions, and
wherein at least one of the directions restricted by the second-first restraint portion and at least one of the directions restricted by the second-second restraint portion are perpendicular to each other.

7. The refrigerant manifold of claim 6, wherein when a plane defined by the intermediate plate is referred to as a reference plane, the restraint portions are distributed and disposed upward, downward, leftward, and rightward so that the first-first restraint portion, the first-second restraint portion, the second-first restraint portion, and the second-second restraint portion do not overlap one another on the reference plane.

8. The refrigerant manifold of claim 2, further comprising:
at least one pair of penetration pins provided at a position, at which the first housing, the second housing, and the intermediate plate triply overlap, and configured to penetrate all the first housing, the second housing, and the intermediate plate,
wherein the penetration pins enhance the restriction of the deviation or rotation of the intermediate plate from the exact position.

9. The refrigerant manifold of claim 8, wherein at least one restraint portion is formed on a straight portion on the first or second housing, and the pair of penetration pins are disposed to be spaced apart from each other in a direction perpendicular to a direction restricted by at least one restraint portion formed on the straight portion on the first or second housing.

10. The refrigerant manifold of claim 8, wherein the plurality of restraint portions are included in the refrigerant manifold, and a larger number of restraint portions are distributed at a side opposite to a side at which the pair of penetration pins are disposed.

11. The refrigerant manifold of claim 8, wherein an external heat exchanger is connected to a portion of the refrigerant manifold where the pair of penetration pins are disposed,
wherein a pair of flow ports are provided to receive an introduced refrigerant from the external heat exchanger or discharge and supply the refrigerant to the external heat exchanger,
wherein a direction in which the pair of flow ports are spaced apart from each other and a direction in which the pair of penetration pins are spaced apart from each other are perpendicular to each other, and
wherein an intersection point between a first connection line, which connects centers of the pair of flow ports, and a second connection line, which connects centers of the pair of penetration pins, overlap center points of the first and second connection lines.
